(19) United States
(12) Patent Application Publication
(10) Pub. No.: US 2014/0041828 A1
(43) Pub. Date: Feb. 13, 2014

(54) VEHICLE AIR-CONDITIONING CONTROL APPARATUS

(71) Applicant: Mazda Motor Corporation, Hiroshima (JP)

(72) Inventor: Makoto YOSHIDA, Hiroshima-shi (JP)

(73) Assignee: Mazda Motor Corporation, Hiroshima (JP)

(21) Appl. No.: 13/950,190

(22) Filed: Jul. 24, 2013

(30) Foreign Application Priority Data
Aug. 10, 2012 (JP) 2012-177790

(51) Int. Cl. B60H 1/00

(52) U.S. Cl. CPC B60H 1/00642
USPC 165/41

(57) ABSTRACT

Provided is a vehicle air-conditioning control apparatus comprising: an air-conditioning system which automatically controls a vehicle interior temperature to conform to a target vehicle interior temperature, in accordance with a first group of given parameters; an engine control section which automatically stops an engine of a vehicle, when a given automatic stop condition including a condition concerning a deviation between the target vehicle interior temperature and an actual vehicle interior temperature is satisfied during a stop of the vehicle; and an automatic stop condition changing section which changes the deviation condition in a direction for allowing the engine to become more likely to be automatically stopped, when a passenger makes a manual operation during the automatic control of the air-conditioning system to change a second parameter other than the first group of given parameters, in a direction for easing the air-conditioning control.

### TECHNICAL FIELD

The present invention relates to a vehicle air-conditioning control apparatus.

### BACKGROUND ART

In the field of vehicle air-conditioning control apparatuses, an automatic air-conditioning system which automatically controls a vehicle interior temperature to conform to a target vehicle interior temperature has become mainstream. The automatic control for air conditioning is performed in accordance with parameters indicative of an environmental condition inside a vehicle interior, an environmental condition outside the vehicle interior, and a passenger's manual air-conditioning operation state (particularly, a manual set value of the target vehicle interior temperature), to automatically set a discharge air temperature of conditioned air, a outlet port of conditioned air, an airflow volume of conditioned air and others.

Meanwhile, in recent vehicles, a so-called “idle stop” for automatically stopping an engine during a stop of a vehicle has been increasingly employed. The idle stop is executed only if a predetermined initiation condition is satisfied. Generally, when all of a plurality of conditions are fulfilled which include: a condition that a vehicle speed is zero (the vehicle is stopped state); a condition that a brake operation is performed; a condition that no accelerator operation is performed; and a condition that a selector of an automatic transmission is in a D position, the idle-stop initiation condition is determined to be satisfied, and thereby the idle stop is executed.

In order to allow an engine in an idle-stop state to be automatically restarted, an automatic restart condition is preliminarily set. Generally, when it becomes unable to satisfy any one of the above conditions included in the initiation condition, for example, when the brake operation by a driver is released, an automatic restart condition is determined to be satisfied, and thereby the engine is restarted.

It is also performed to prohibit the idle stop in a situation where it is undesirable to execute engine automatic stop (idle stop). A condition for this idle-stop prohibition includes various conditions unrecognizable by a driver. For example, when any one of various conditions is satisfied which include: a condition that a battery charge amount is excessively small; a condition that battery power consumption is excessively large; a condition that a engine coolant temperature or engine oil temperature is excessively low; a condition that a transmission oil temperature or oil pressure is excessively low; and a condition that a difference between target and actual vehicle interior temperatures is excessively large, i.e., an air-conditioning level required for an air-conditioning system is excessively high, the idle-stop prohibition condition is determined to be satisfied, and thereby the execution of the idle stop is prohibited. Further, even after the idle stop is executed once, the engine is restarted at a time when the idle-stop prohibition condition is satisfied during the course of the idle stop, in some cases. The idle-stop initiation condition may be set as a part of the idle-stop prohibition condition. In this case, when even one of a plurality of conditions making up the idle-stop prohibition condition is not satisfied (e.g., no brake operation is performed), the idle-stop prohibition condition may be deemed to be satisfied.

Here, suppose a condition that the required air-conditioning level is excessively high is included in the idle-stop prohibition condition. In this case, the idle stop is prohibited when a deviation between the target vehicle interior temperature and the actual vehicle interior temperature is excessively large. For example, in the case where, during cooling, the actual vehicle interior temperature is greater than the target vehicle interior temperature by a given value or more, or, in the case where, during heating, the actual vehicle interior temperature is less than the target vehicle interior temperature by a given value or more, the idle stop is prohibited so as to give priority to the air conditioning.

There are some passengers who strongly desire to increase frequency of the idle stops to enhance fuel economy. In this case, how to achieve a balance with a demand from the air conditioning becomes a problem. JP 2006-240459A discloses a technique of allowing a weighting level of the idle stop and a weighting level of the air conditioning to be selected by a passenger's manual manipulation.

The technique described in the JP 2006-240459A is configured to allow a passenger to manually select simply whether to give weight on the idle stop or the air conditioning. Thus, for example, when the passenger makes a selection to give weight on the idle stop, the air conditioning has to be largely sacrificed.

On the other hand, under a recognition that an operating state of an air-conditioning system is associated with the idle stop, with a view to reduce a load on the air-conditioning system, some passengers make a manual operation, for example, to reduce an airflow volume of conditioned air. However, in this case, a time period required before allowing the actual vehicle interior temperature to come close to the target vehicle interior temperature becomes unnecessarily extended, which is undesirable in terms of the air conditioning and in view of allowing the idle stop to become more likely to be executed.

### SUMMARY OF THE INVENTION

In view of the above circumstances, it is an object of the present invention to provide a vehicle air-conditioning control apparatus capable of fulfilling both needs for air conditioning and idle stop at a high level.

In order to achieve the above object, the present invention provides a vehicle air-conditioning control apparatus comprising: an air-conditioning system which automatically controls a vehicle interior temperature to conform to a target vehicle interior temperature, in accordance with first parameters indicative of at least one of an environmental condition inside a vehicle interior and an environmental condition outside the vehicle interior, and a manual operation state set by a passenger; an engine control section which automatically stops an engine of a vehicle, when a given automatic stop condition including a condition concerning a deviation between the target vehicle interior temperature and an actual vehicle interior temperature is satisfied during a stop of the vehicle; and an automatic stop condition changing section which changes the deviation condition in a direction for allowing the engine to become more likely to be automatically stopped, when a passenger makes a manual operation during the automatic control of the air-conditioning system to change a second parameter other than the first parameters, in a direction for easing the air-conditioning control.

The present invention can fulfill both needs for air conditioning and idle stop at a high level.

### BRIEF DESCRIPTION OF THE DRAWINGS

FIG. 1 is a system diagram illustrating one example of an air-conditioning system.

FIG. 2 is a schematic diagram illustrating one example of an air-conditioning operation panel.

FIG. 3 is a block diagram illustrating one example of a control system for the air-conditioning system.

FIG. 4 is a block diagram illustrating one example of an engine automatic stop control system.

FIG. 5 is a time chart illustrating one example of control according to the present invention, during cooling.

FIG. 6 is a time chart illustrating one example of the control according to the present invention, during heating.

FIG. 7 is a characteristic graph illustrating one example of setting of an amount of change in threshold temperature with respect to an amount of decreased in airflow volume of conditioned air.

FIG. 8 is a characteristic graph illustrating another example of the setting of the amount of change in threshold temperature with respect to the amount of decreased in airflow volume of conditioned air.

FIG. 9 is a flowchart illustrating one example of the control according to the present invention.

### DESCRIPTION OF EMBODIMENTS

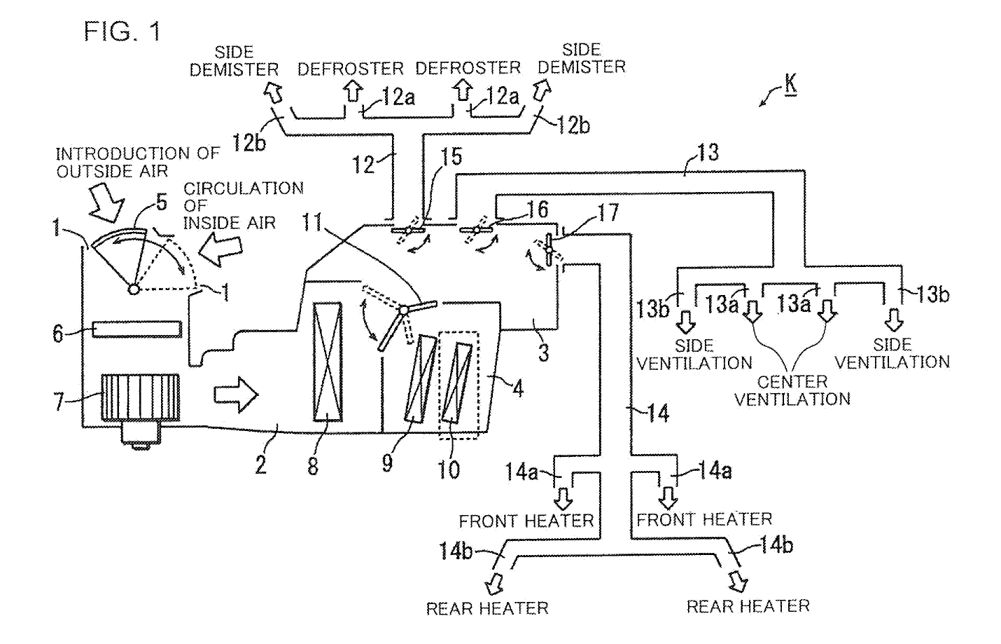

FIG. 1 illustrates one example of a passage configuration of an air-conditioning system K. The air-conditioning system K is a well-known type, and therefore will be briefly described as follows. It comprises an upstream passage portion 2 having an inlet port 1, and an air mix chamber 3 and a heating chamber 4 each connected to a downstream side of the upstream passage portion 2. The inlet port 1 is provided with a switching damper 5 to switch between a position for inside air circulation and a position for outside air introduction. The upper upstream passage portion 2 houses an air filter 6, a sucking blower 7, and an evaporator 8 for allowing a cooling medium to be circulated therethrough, which are disposed on a downstream side of the switching damper 5 in this order.

The heating chamber 4 is internally provided with a first heater core 9 for allowing an engine coolant to be circulated therethrough, and an electric second heater core 10. In this embodiment, the electric second heater core 10 is employed, because an engine is a direct-injection type in which an engine coolant temperature is less likely to be raised. However, the second heater core 10 may be omitted, depending on a type of engine or the like.

An air mix damper 11 is disposed in a connection region between the upstream passage portion 2 and each of the air mix chamber 3 and the heating chamber 4. The air mix damper 11 is rotated in such a manner that a rate of cooling air passing through the evaporator 8 via the heating chamber 4 is changed according to a rotational position of the air mix damper 11, to thereby adjust a temperature and humidity of air to be introduced into the air mix chamber 3.

Three passages 12 to 14 are connected to the air mix chamber 3. The passage 12 has a terminal end portion branched into a plurality of sub-passages which serve as a pair of defroster outlet ports 12a, and a pair of side demister outlet ports 12b. The passage 13 has a terminal end portion branched into a plurality of sub-passages which serve as a pair of center ventilation outlet ports 13a, and a pair of side ventilation outlet ports 13b. The passage 14 has a terminal end portion branched into a plurality of sub-passages which serve as a pair of front heater outlet ports 14a, and a pair of rear heater outlet ports 14b. Each of three mode-switching mode dampers 15, 16, 17 is disposed in a connection region between the air mix chamber 3 and a respective one of the three passages 12, 13, 14.

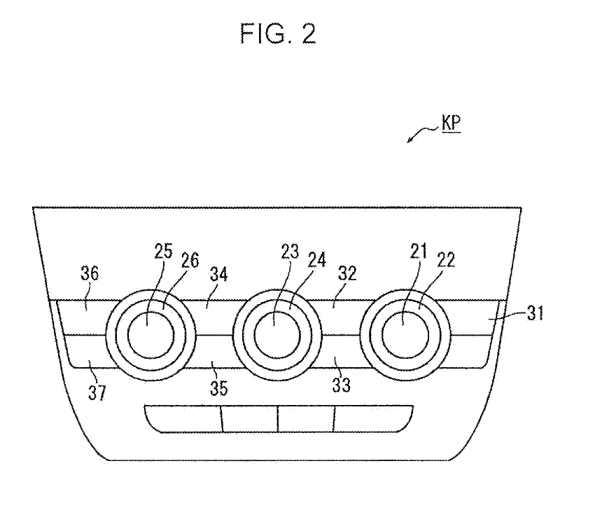

FIG. 2 illustrates one example of an air-conditioning panel unit KP provided to be operated by a passenger and set up in an instrument panel. In this embodiment, the air-conditioning panel unit KP is compatible with a system in which temperature control is performed on respective sides of a driver seat and a front passenger seat, laterally separately, and configured to have a plurality of switches 21 to 26, 31 to 37 each capable of being manually operated by a passenger in the following manner.

The switch 21 is a main switch designed to turn on an automatic air-conditioning mode, and composed of a push switch. The switch 22 is designed to set a driver seat-side temperature, and composed of a dial switch. The switch 23 is designed to turn off the automatic air-conditioning mode, and composed of a push switch. The switch 24 is designed to adjust an airflow volume of conditioned air, and composed of a dial switch. The switch 25 is designed to be manually operated when selecting independent setting of a front passenger seat-side temperature, and composed of a push switch. The switch 26 is designed to adjust the front passenger seat-side temperature, and composed of a dial switch.

The switch 31 is designed to turn off an air-conditioner (a compressor for cooling). The switch 32 is designed to activate a front defroster. The switch 33 is designed to activate a rear defroster. Each of the switches 34, 35 is designed to select a outlet port of conditioned air. The switch 36 is designed to select an outside air introduction mode. The switch 37 is designed to select an inside air circulation mode. Each of the switches 31 to 37 is composed of a push switch.

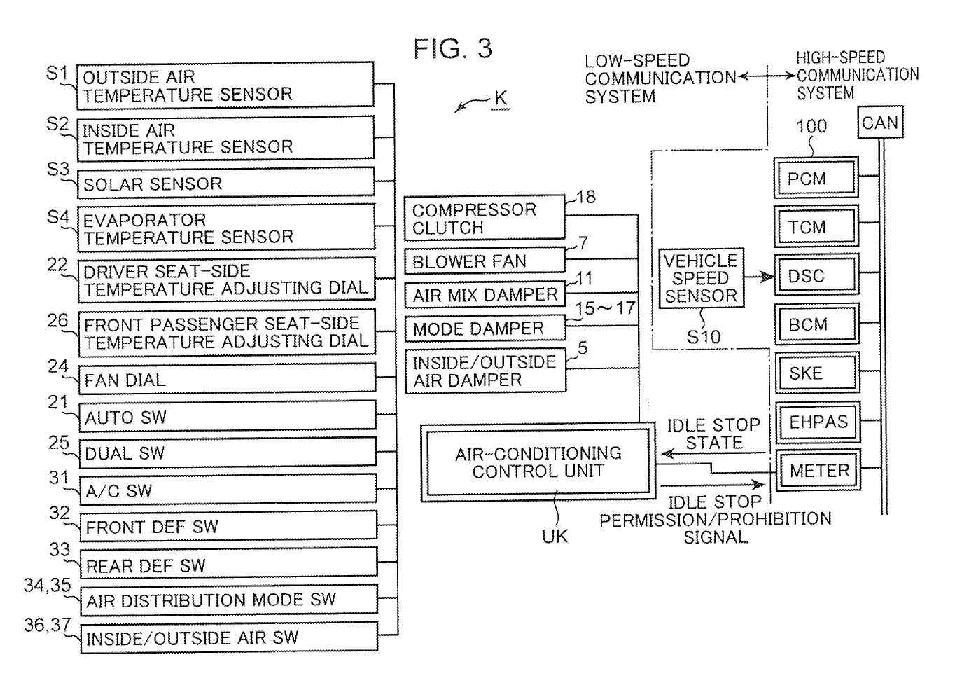

FIG. 3 illustrates a control system for the air conditioning system K. In FIG. 3, the code UK indicates an air-conditioning system controller (control unit) constructed using a microcomputer. The controller UK receives inputs of signals from the above various switches, and further inputs of signals indicative of an outside air temperature detected by an outside air temperature sensor S1, a vehicle interior temperature detected by an inside air temperature sensor S2, a vehicle interior sunlight intensity detected by a solar sensor S3, and a temperature of the evaporator 8 detected by a temperature sensor S4. The controller UK controls the aforementioned devices 5, 7, 11, 15 to 17, such as dampers, and a compressor clutch 18 interposed in a driving force transmission line between an engine and a compressor for compressing a cooling medium. The controller UK and each of the above sensors, switches and devices are connected by a low-speed communication system.

The controller UK is fundamentally operable, in accordance with environmental conditions inside and outside the vehicle interior detected by sensors S1 to S4 and a manual operation state of the switches set by a passenger, to set a target vehicle interior temperature, and automatically control an airflow volume of conditioned air, a temperature of conditioned air, a selection of conditioned air outlet ports, etc., in a manner best suited to allow an actual vehicle interior temperature to conform to the target vehicle interior temperature. Such automatic control for air conditioning is the same as a conventional control, and its further detailed description will be omitted.

The controller UK included in the low-speed communication system is connected to a high-speed communication system (CAN) via a meter provided in the instrument panel. The high-speed communication system comprises: a PCM (Powertrain Control Module) 100 serving as an engine control section for performing control including engine automatic stop and engine automatic restart; a TCM (Transmission Control Module) for performing gear shift control of an automatic transmission; a DSC (Dynamic Stability Control) module for performing brake control including automatic brake control when automatically stopping the engine; BCM (Body Control Module) for performing control associated with a vehicle body, including a detection of open and closed states of doors; a keyless control module (indicated by SKE) for performing control for smart keyless entry, including a detection of misplacement of a car key within a vehicle; and EHPAS (Electro-Hydraulic Power Assisted System) for performing power steering control. Information about an idle stop state is input from the PCM 100 into the controller UK. On the other hand, an idle stop permission or prohibition signal is input from the controller UK into the PCM 100, depending on a state of air-conditioning control, as described later. Further, a vehicle speed sensor 10 is connected to the DSC module. A vehicle speed signal detected by the vehicle speed sensor 10 is input into the controller UK and the PCM 100 via the CAN.

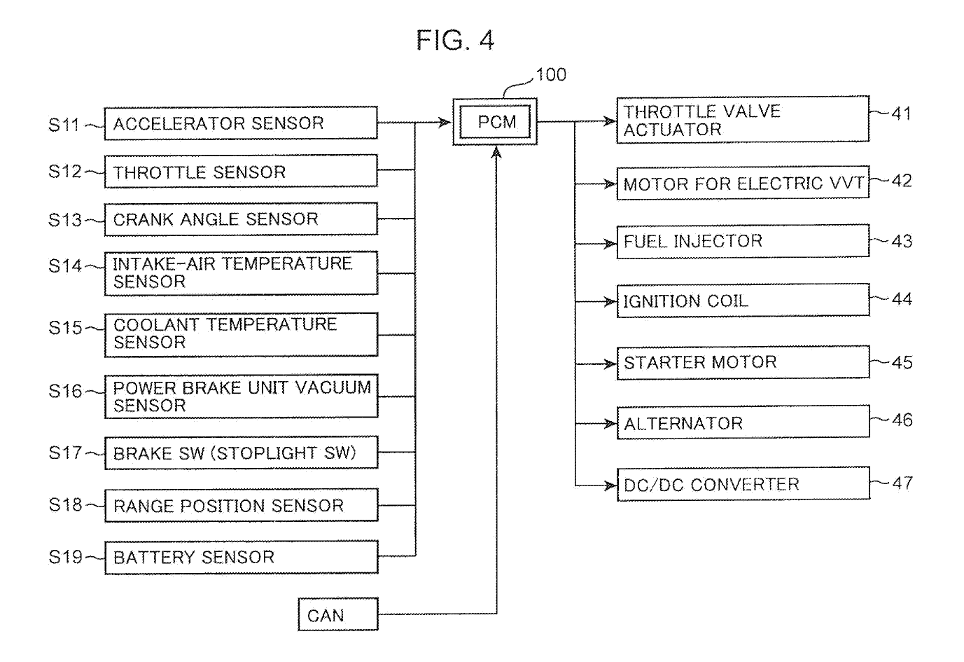

FIG. 4 illustrates one example of a detailed control system including the PCM 100, for performing idle stop control. In FIG. 4, signals from various sensors or switches S11 to S19 are input into the PCM 100. The sensor S11 is an accelerator sensor for detecting an accelerator pedal depression degree. The sensor S12 is a throttle sensor for detecting a throttle valve opening degree. The sensor S13 is an angle sensor for detecting a rotational angle position of a crankshaft. The sensor S14 is an intake-air temperature sensor for detecting an intake-air temperature. The sensor S15 is a coolant temperature sensor for detecting an engine coolant temperature. The sensor S16 is a vacuum sensor for detecting a vacuum in a brake system equipped with a vacuum brake booster. The switch S17 is a brake switch for detecting that a brake pedal is depressed (it also serves as a stoplight switch). The switch S18 is a range position sensor for detecting that a range position of an automatic transmission. The switch S19 is a battery sensor for comprehensively detecting a charge amount, voltage, current consumption, etc., of a battery.

The PCM 100 controls the following devices 41 to 47, in connection with the engine automatic stop (idle stop) and automatic restart controls. The reference numeral 41 indicates an actuator for driving a throttle valve. The PCM 100 is operable, when automatically stopping the engine, to instruct the actuator 41 to fully close the throttle valve. The reference numeral 42 indicates a drive motor for an electrically-operated variable valve timing apparatus. The PCM 100 is operable, in advance of the engine automatic restart, to instruct the drive motor 42 to delay an opening-closing timing of an intake valve. The reference numeral 43 indicates a fuel injector. The PCM 100 is operable, in order to perform the engine automatic stop, to instruct the fuel injector 13 to stop fuel injection. The reference numeral 44 indicates an ignition coil. The PCM 100 is operable, when automatically stopping the engine, to stop current supply to the ignition coil 44 to prohibit ignition. The reference numeral 45 indicates a starter motor. The PCM 100 is operable, when automatically restarting the engine, to drive the starter motor 45. The reference numeral 46 indicates an alternator. The PCM 100 is operable, when automatically stopping the engine, to increase a load on the alternator 46 to reduce an engine speed. The reference numeral 47 indicates a DC/DC converter. The PCM 100 is operable, when engine cranking is performed for the engine automatic restart, to control the DC/DC converter 47 to compensate for lowering in battery power.

The idle stop for automatically stopping the engine is performed during a stop of the vehicle. This is executed on condition that even one of the following conditions making up an idle stop prohibition condition is not satisfied.

Automatic Stop Prohibition Condition (Idle Stop Prohibition Condition)

(1) The vehicle speed is not zero.

(2) No brake operation by a passenger is performed.

(3) The accelerator pedal is depressed.

(4) The battery is in the following state: a battery voltage is equal to or less than a predetermined given value; a charge amount is equal to or less than a predetermined given value; a current consumption is equal to or greater than a predetermined given value; or a battery control system is in an abnormal state (when an abnormal signal is generated).

(5) A steering wheel angle is not within a given small angular range with respect to a neutral position of a steering wheel.

(6) The transmission is in the following state: a selector of the transmission is not in a D range position; an oil temperature is not within a given temperature range; an oil pressure is not within a given pressure range; and a transmission abnormal signal is generated; or a clutch (including a lockup clutch) has an abnormality.

(7) The engine is in the following state: the engine coolant temperature is not within a given temperature range; or the intake-air temperature is excessively high, and an atmospheric pressure is relatively low.

(8) A vacuum in the vacuum brake booster-equipped brake system is insufficient, or a signal indicative of abnormality of an engine system is generated.

(9) A system associated with the vehicle body is in the following state: an ignition key is carried out of a vehicle (in case of a smart keyless entry system); a seat belt is detached; any door is opened; or a hood (bonnet) is opened.

(10) A road surface has a large inclined angle.

(11) An automatic stop prohibition signal is output from the air-conditioning controller UK (this condition will be described in detail later).

The above automatic stop prohibition condition is described by way of example only, and it is to be understood that any other suitable condition may be added thereto. For example, a condition that an IS switch (not illustrated) for cancelling (prohibiting) the engine automatic stop by a driver's intention is turned on, or a condition that the engine speed is equal to or greater than a predetermined value (i.e., fairly greater than a stable idle speed), may further be added. Conversely, the prohibition condition may be set by eliminating a part of the above conditions.

An automatic restart condition for automatically restarting an automatically stopped engine, i.e., an engine in the idle stop state, may be a condition that any one of the above conditions making up the automatic stop prohibition condition is released. Particularly preferably, at least a condition that the brake operation by a passenger is released is set as the automatic restart condition.

An automatic stop prohibition condition associated with the air-conditioning system K will be described below. The air-conditioning automatic control is performed to allow an actual vehicle interior temperature detected by the inside air temperature sensor S2 to come close to a target vehicle interior temperature set based on the temperature adjusting dials 22, 26 selected by a passenger. During the air-conditioning automatic control, a temperature of conditioned air, a selection of conditioned air outlet ports, an airflow volume of conditioned air, etc., are automatically adjusted.

The air-conditioning controller UK outputs a prohibition signal for prohibiting the engine automatic stop during a stop of the vehicle so as to give priority to air-conditioning, in the following situations. On the other hand, when the air-conditioning controller UK does not output the automatic stop prohibition signal, it outputs an automatic stop permission signal.

Automatic Stop Prohibition Condition set from Air-Conditioning System

(1) Abnormality occurs in any of the sensors and switches in the air-conditioning system K.

(2) The outside air temperature is significantly high (e.g., 40° C. or more) or significantly low (e.g.,−10° C. or less).

(3) The defroster is used (priority is given to ensuring visibility).

(4) The target vehicle interior temperature selectively set by a passenger is a high temperature-side upper limit (a demand for heating is significantly strong).

(5) The target vehicle interior temperature selectively set by a passenger is a low temperature-side lower limit and the air-conditioner (compressor) is turned on (a demand for cooling is significantly strong).

(6) A deviation between the target vehicle interior temperature and the actual vehicle interior temperature is greater than a given value.

The air-conditioning controller UK has a function (function as an automatic stop condition changing section) of appropriately changing the condition (6) concerning the deviation between the target vehicle interior temperature and the actual vehicle interior temperature, among the above conditions making up the automatic stop prohibition condition, in a direction for allowing the engine to become more likely to be automatically stopped (in a direction causing a chance for the idle stop to increase) depending on a manual air-conditioning operation by a passenger.

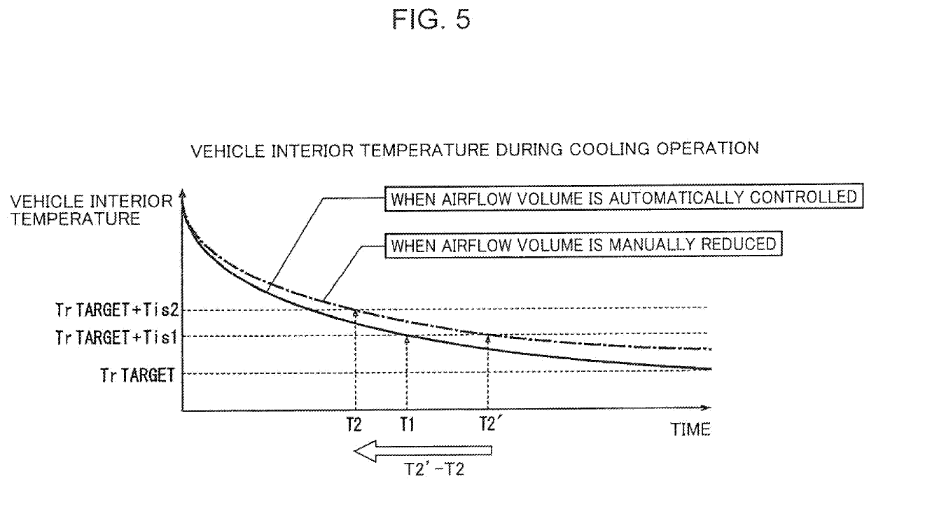

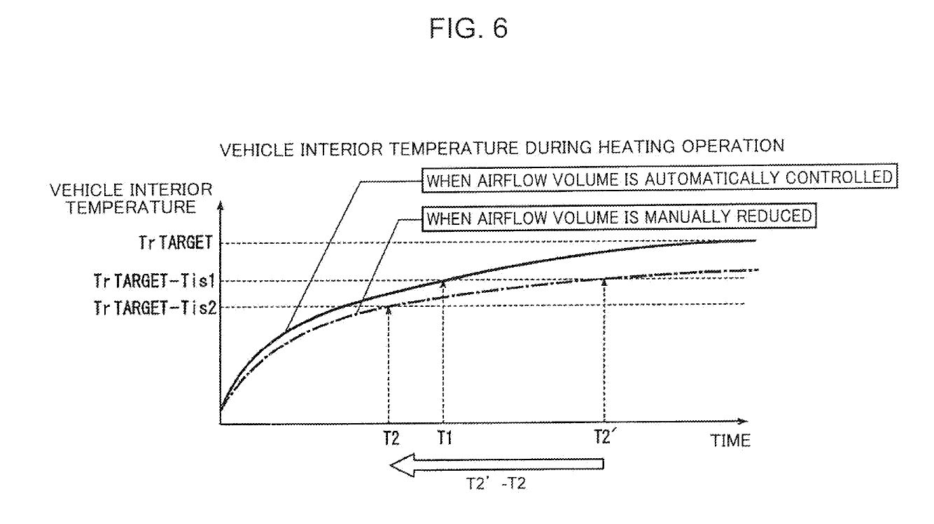

With reference to FIGS. 5 and 6, this point will be described below.

FIG. 5 illustrates a temporal change in vehicle interior temperature during cooling, wherein the solid line indicates a curve obtained when air-conditioning parameters are fully automatically controlled, and the one-dot chain line indicates a curve obtained when the airflow volume of conditioned air is reduced by a passenger's manual operation (remaining parameters other than the airflow volume are automatically controlled). In the one-dot chain line obtained when the airflow volume is reduced, a decrease in the actual vehicle interior temperature becomes moderate, as compared to the solid line.

In FIG. 5, Tr TARGET represents the target vehicle interior temperature. Tis1 represents a first threshold, and Tis2 represents a second threshold. The first and second thresholds Tis1, Tis2 are set to satisfy the following relation: Tis2>Tis1>0. A first given temperature greater than the target vehicle interior temperature Tr TARGET by the first threshold Tis1 is set as “Tr TARGET+Tis1”, and a second given temperature greater than the target vehicle interior temperature Tr TARGET by the second threshold Tis2 is set as “Tr TARGET+Tis2”.

The first given temperature “Tr TARGET+Tis1” is a threshold temperature to determine whether the engine automatic stop is prohibited or permitted, when the air-conditioning parameters are fully automatically controlled. That is, the controller UK is operable, when the actual vehicle interior temperature is equal to or less than the first given temperature “Tr TARGET+Tis1”, to output the engine automatic stop permission signal, and, when the actual vehicle interior temperature is greater than the first given temperature “Tr TARGET+Tis1”, to output the engine automatic stop prohibition signal. In the solid line in FIG. 5, a time when the actual vehicle interior temperature becomes equal to the first given temperature “Tr TARGET+Tis1” corresponds to the time T1.

On the other hand, the second given temperature “Tr TARGET+Tis2” is a threshold temperature to determine whether the engine automatic stop is prohibited or permitted, when an operation of reducing the airflow volume of conditioned air is performed by a passenger from the state in which the air-conditioning parameters are fully automatically controlled. That is, the controller UK is operable, when the actual vehicle interior temperature is equal to or less than the second given temperature “Tr TARGET+Tis2”, to output the engine automatic stop permission signal, and, when the actual vehicle interior temperature is greater than the second given temperature “Tr TARGET+Tis2”, to output the engine automatic stop prohibition signal. In this case, as indicated by the one-dot chain line in FIG. 5, a time when the actual vehicle interior temperature is reduced to the second given temperature “Tr TARGET+Tis2” corresponds to the time T2.

In a temperature change as indicated by the one-dot chain line in FIG. 5, a time when the actual vehicle interior temperature is reduced to the first given temperature “Tr TARGET+Tis1” corresponds to the time T2′, which is a fairly late timing. When the threshold temperature for permitting the engine automatic stop is set to a higher value, i.e., to the second given temperature “Tr TARGET+Tis2”, a time period required before permission of the engine automatic stop is shortened (a timing of permission of the engine automatic stop is advanced from the time T2′ to the time T2).

FIG. 6 illustrates a temporal change in vehicle interior temperature during heating, wherein the solid line indicates a curve obtained when air-conditioning parameters are fully automatically controlled, and the one-dot chain line indicates a curve obtained when the airflow volume of conditioned air is reduced by a passenger's manual operation. In the one-dot chain line obtained when the airflow volume is reduced, an increase in the actual vehicle interior temperature becomes moderate, as compared to the solid line.

In FIG. 6, Tr TARGET represents the target vehicle interior temperature. Tis1 represents a first threshold, and Tis2 represents a second threshold. The first and second thresholds Tis1, Tis2 are set to satisfy the following relation: Tis2>Tis1>0. A third given temperature less than the target vehicle interior temperature Tr TARGET by the first threshold Tis1 is set as “Tr TARGET−Tis1”, and a fourth given temperature less than the target vehicle interior temperature Tr TARGET by the second threshold Tis2 is set as “Tr TARGET−Tis2”.

The third given temperature “Tr TARGET−Tis1” is a threshold temperature to determine whether the engine automatic stop is prohibited or permitted, when the air-conditioning parameters are fully automatically controlled. That is, the controller UK is operable, when the actual vehicle interior temperature is equal to or greater than the third given temperature “Tr TARGET−Tis1”, to output the engine automatic stop permission signal, and, when the actual vehicle interior temperature is less than the third given temperature “Tr TARGET−Tis1”, to output the engine automatic stop prohibition signal. In the solid line in FIG. 5 indicating a change in the actual vehicle interior temperature when the air-conditioning parameters are fully automatically controlled, a time when the actual vehicle interior temperature becomes equal to the third given temperature “Tr TARGET−Tis1” corresponds to the time T1.

On the other hand, the fourth given temperature “Tr TARGET−Tis2” is a threshold temperature to determine whether the engine automatic stop is prohibited or permitted, when an operation of reducing the airflow volume of conditioned air is performed by a passenger from the state in which the air-conditioning parameters are fully automatically controlled. That is, the controller UK is operable, when the actual vehicle interior temperature is equal to or greater than the fourth given temperature “Tr TARGET−Tis2”, to output the engine automatic stop permission signal, and, when the actual vehicle interior temperature is less than the fourth given temperature “Tr TARGET−Tis2”, to output the engine automatic stop prohibition signal. In this case, as indicated by the one-dot chain line in FIG. 6, a time when the actual vehicle interior temperature is increased to the fourth given temperature “Tr TARGET−Tis2” corresponds to the time T2.

In a temperature change as indicated by the one-dot chain line in FIG. 6, a time when the actual vehicle interior temperature is increased to the third given temperature “Tr TARGET−Tis1” corresponds to the time T2′, which is a fairly late timing. When the threshold temperature for permitting the engine automatic stop is set to a lower value, i.e., to the fourth given temperature “Tr TARGET−Tis2”, a time period required before permission of the engine automatic stop is shortened (a timing of permission of the engine automatic stop is advanced from the time T2′ to the time T2).

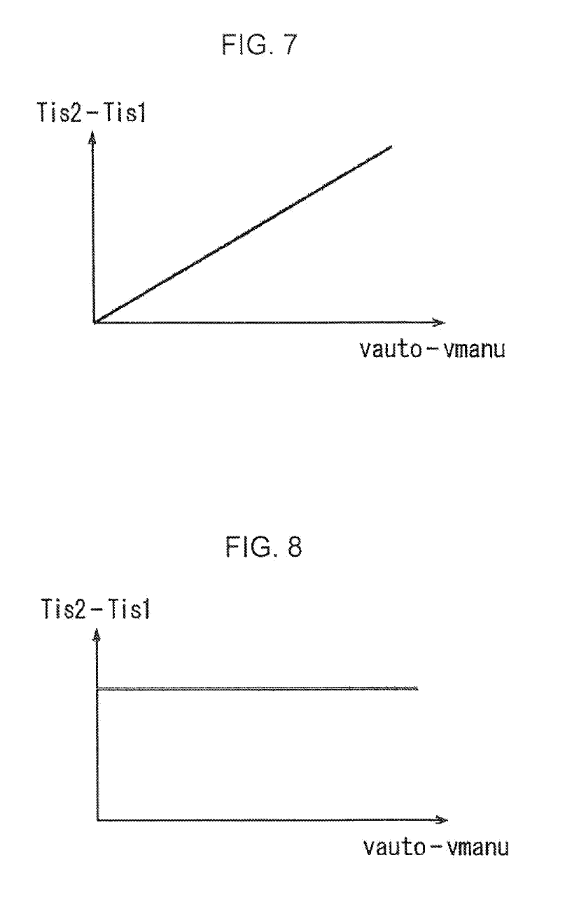

In the case where the first threshold Tis1 is constant, the timing of permission of the engine automatic stop is further advanced as the second threshold Tis2 becomes larger. FIGS. 7 and 8 illustrate examples in which a value “Tis2−Tis1” is changed according to an amount of decrease in airflow volume of conditioned air by a passenger's manual operation. The “Tis2−Tis1” (vertical axis in FIGS. 7 and 8) represents an increased amount when the threshold temperature during cooling is increased from the first given temperature to the second given temperature, or a reduced amount when the threshold temperature during heating is reduced from the third given temperature to the fourth given temperature. In FIGS. 7 and 8, “vauto” on the horizontal axis represents the airflow volume of conditioned air when the air-conditioning parameters are fully automatically controlled, and “vmanu” on the horizontal axis represents the airflow volume of conditioned air according to the passenger's manual operation. Further, a difference “vauto−vmanu” represents an amount of decrease in airflow volume of conditioned air.

The example in FIG. 7 is a line obtained when the value “Tis2−Tis1” is changed to linearly increase as the amount of decrease in the airflow volume of conditioned air becomes larger. That is, FIG. 7 illustrates an example of a setting in which the value “Tis2−Tis1” is proportional to an amount of change in the airflow volume. In this setting, a time period required before output of the automatic stop permission signal is shortened in proportion to the amount of decrease in the airflow volume of conditioned air based on the passenger's manual operation, so that the timing of permission of the automatic stop is set to timing adequately in conformity with a ratio between a need for the air-conditioning need presumed from the passenger's manual operation and a need for the automatic stop.

The example in FIG. 8 is a line obtained when the value “Tis2−Tis1” is set to become constant, irrespective of the airflow volume of conditioned air. That is, FIG. 8 illustrates an example of a setting in which the value “Tis2−Tis1” is set to be unrelated to the amount of change in the airflow volume. In this setting, the timing of permission of the automatic stop is uniformly advanced, irrespective of a level of need for the automatic stop, which is desirable in simplifying the control.

The “Tis2−Tis1” line is not limited to the above examples in FIGS. 7 and 8, but any other suitable line may be selected. For example, a line may be employed in which the value “Tis2−Tis1” (i.e., a value of Tis2) is changed in a stepwise manner, or in a non-linearly continuous manner.

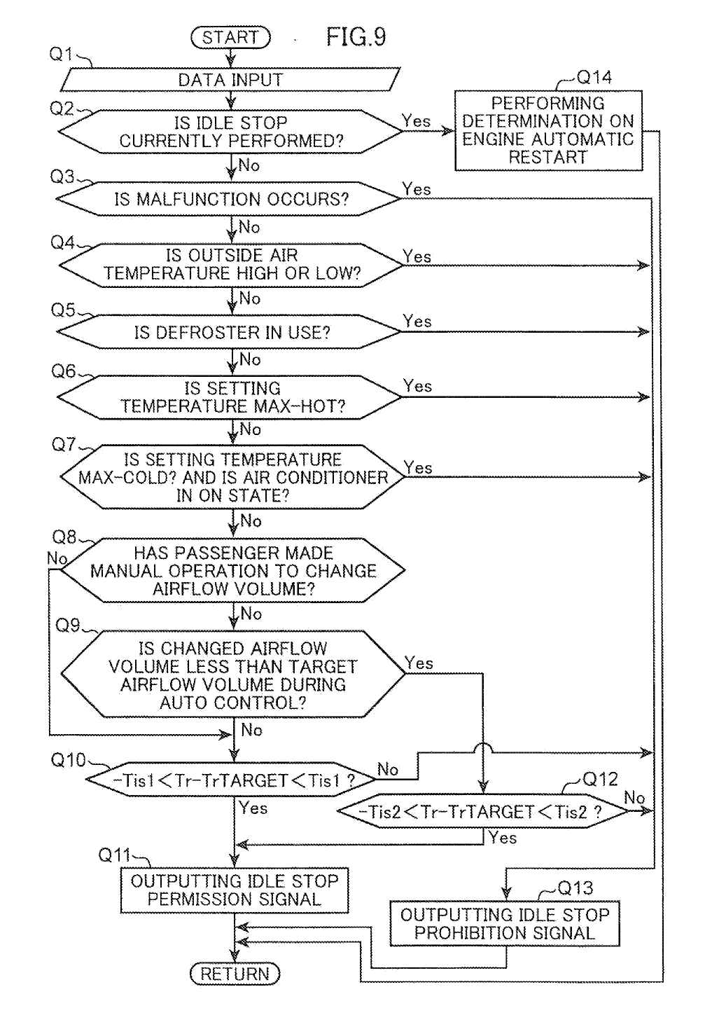

FIG. 9 is a flowchart illustrating one example of a part of the control by the controller UK concerning an output of the automatic stop permission signal and an output of the automatic stop inhibition signal. The flowchart will be described below, wherein “Q” denotes “step”.

First of all, in Q1, signals from the sensors and switches are read (data input). Then, in Q2, it is determined whether or not the idle strop is currently performed. When the determination in the Q2 is made as NO, it is determined, in Q3 to Q7, whether or not the automatic stop prohibition condition other than the condition concerning the deviation between the target vehicle interior temperature and the actual vehicle interior temperature in the air-conditioning system K. Specifically, in the Q3, it is determined whether or not malfunction occurs in the sensors and switches. When the determination in the Q3 is made as NO, it is determined, in the Q4, whether or not the outside air temperature is significantly high or significantly low. When the determination in the Q4 is made as NO, it is determined, in the Q5, whether or not the defroster is in use. When the determination in the Q5 is made as NO, it is determined, in the Q6, whether or not a temperature set by a passenger is a high temperature-side upper limit. When the determination in the Q6 is made as NO, it is determined, in the Q7, whether or not the temperature set by a passenger is a low temperature-side lower limit, and the air-conditioner (compressor) is in its ON state.

When the determination in the Q7 is made as NO, it is determined, in the Q8, whether or not a passenger has made a manual operation to change the airflow volume of conditioned air. When the determination in the Q8 is made as NO, it is determined, in the Q10, whether or not a value obtained by subtracting the target vehicle interior temperature Tr TARGET from the actual vehicle interior temperature Tr falls within the range of −Tis1 to +Tis1. When the determination in the Q10 is made as YES, the idle stop permission signal is output in the Q11. On the other hand, when the determination in the Q10 is made as NO, the idle stop prohibition signal is output in the Q13. The operation from the Q10 to the Q11 or Q13 corresponds to control to be performed when the air-conditioning parameters are fully automatically controlled, specifically, control along with a temperature change, as indicated by the solid line in FIG. 5 or 6.

When the determination in the Q8 is made as YES, it is determined, in the Q9, whether or not the target airflow volume of conditioned air changed by the passenger's manual operation is less than that during the automatic control. When the determination in the Q9 is made as NO, the process advances to the Q10.

When the determination in the Q9 is made as YES, it is determined, in the Q12, whether or not a value obtained by subtracting the target vehicle interior temperature Tr TARGET from the actual vehicle interior temperature Tr falls within the range of −Tis2 to +Tis2. When the determination in the Q12 is made as YES, the idle stop permission signal is output in the Q11. On the other hand, when the determination in the Q12 is made as NO, the idle stop prohibition signal is output in the Q13. The operation from the Q12 to the Q11 or Q13 corresponds to control along with a temperature change, as indicated by the one-dot chain line in FIG. 5 or 6.

When the determination in the Q2 is made as YES, it is determined, in the Q14, whether or not the engine automatic restart is performed.

The present invention has been described based on the preferred embodiment thereof. It is to be understood that the present invention is not limited to the above embodiment, but various changes and modification may be made therein without departing from the spirit and scope thereof as set forth in appended claims. For example, the present invention encompasses the following modifications.

In the above embodiment, as a manual operation of changing the condition concerning the deviation between the target vehicle interior temperature and the actual vehicle interior temperature, in a direction for allowing the engine to become more likely to be automatically stopped, the threshold temperature of the vehicle interior temperature (threshold of the vehicle interior temperature for determining whether the idle stop is prohibited or permitted) is changed. Alternatively, the target vehicle interior temperature or the actual vehicle interior temperature may be directly changed in a pseudo manner. Further, a parameter to be changed by the passenger's manual operation to thereby change the deviation condition (allow the engine to become more likely to be automatically stopped) is not limited to the airflow volume of conditioned air. Alternatively, for example, when an air circulation mode during cooling is changed from an inside air circulation mode to an outside air introduction mode, or when a manual operation for changing a outlet port of conditioned air is performed (when the air distribution mode switches 34, 35 in FIG. 2 are manually operated), the deviation condition may be changed. An object of the present invention is not limited to an explicitly described one, but implicitly includes providing any technical matter expressed as a preferred or advantage feature.

Lastly, features of the vehicle air-conditioning control apparatus disclosed in the above embodiment and advantages based on the vehicle air-conditioning control apparatus will be outlined.

The vehicle air-conditioning control apparatus comprises: an air-conditioning system which automatically controls a vehicle interior temperature to conform to a target vehicle interior temperature, in accordance with first parameters indicative of at least one of an environmental condition inside a vehicle interior and an environmental condition outside the vehicle interior, and a manual operation state set by a passenger; an engine control section which automatically stops an engine of a vehicle, when a given automatic stop condition including a condition concerning a deviation between the target vehicle interior temperature and an actual vehicle interior temperature is satisfied during a stop of the vehicle; and an automatic stop condition changing section which changes the deviation condition in a direction for allowing the engine to become more likely to be automatically stopped, when a passenger makes a manual operation during the automatic control of the air-conditioning system to change a second parameter other than the first parameters, in a direction for easing the air-conditioning control.

In the vehicle air-conditioning control apparatus, when a passenger makes a manual operation for easing the air-conditioning control, it becomes possible to reflect intention of the passenger to allow the engine to become more likely to be automatically stopped, while continuing the air-conditioning control for controlling the actual vehicle interior temperature toward the target vehicle interior temperature, and thereby satisfy both respective needs for the air conditioning and the idle stop at a high level.

Preferably, in the above vehicle air-conditioning control apparatus, the second parameter is an airflow volume of conditioned air, wherein the automatic stop condition changing section is operable, when the passenger's manual operation is performed to reduce the airflow volume of conditioned air, to change the deviation condition in a direction for allowing the engine to become more likely to be automatically stopped.

According to this feature, it becomes possible to increase a chance for the idle stop, based on a manual operation of reducing the airflow volume of conditioned air, which is frequently performed by a passenger as a manual operation for easing the air-conditioning control.

Preferably, in the above vehicle air-conditioning control apparatus, when the actual vehicle interior temperature during cooling becomes equal to or less than a threshold temperature set to a value higher than the target vehicle interior temperature, the deviation condition is determined to be fulfilled, and thereby the engine automatic stop is permitted, wherein the automatic stop condition changing section is operable, when the passenger's manual operation is performed to reduce the airflow volume of conditioned air, to increase the threshold temperature during the cooling from a first given temperature to a second given temperature higher than the first given temperature.

According to this feature, it becomes possible to increase a chance for the idle stop, during cooling, by a simple method of increasing the threshold temperature to permit the engine automatic stop.

Preferably, the above vehicle air-conditioning control apparatus, when the actual vehicle interior temperature during heating becomes equal to or more than a threshold temperature set to a value lower than the target vehicle interior temperature, the deviation condition is determined to be fulfilled, and thereby the engine automatic stop is permitted, wherein the automatic stop condition changing section is operable, when the passenger's manual operation is performed to reduce the airflow volume of conditioned air, to reduce the threshold temperature during the heating from a third given temperature to a fourth given temperature lower than the third given temperature.

According to this feature, it becomes possible to increase a chance for the idle stop, during heating, by a simple method of reducing the threshold temperature to permit the engine automatic stop.

Preferably, the above vehicle air-conditioning control apparatus, an amount of increase from the first given temperature to the second given temperature is set to a value which is unrelated to an amount of change in the airflow volume of conditioned air by a passenger, or an amount of decrease from the third given temperature to the fourth given temperature is set to a value which is unrelated to an amount of change in the airflow volume of conditioned air by a passenger.

According to this feature, it becomes possible to reliably increase a chance for the idle stop, according to a passenger's intention to frequently perform the idle stop.

Preferably, in the above vehicle air-conditioning control apparatus, an amount of increase from the first given temperature to the second given temperature is set to a value which is proportional to an amount of change in the airflow volume of conditioned air by a passenger, or an amount of decrease from the third given temperature to the fourth given temperature is set to a value which is proportional to an amount of change in the airflow volume of conditioned air by a passenger.

According to this feature, it becomes possible to set a level of likelihood of the idle stop to a level adequately in conformity with a degree of passenger's intention to perform the idle stop.

The second parameter may be an air circulation mode during cooling. In this case, the automatic stop condition changing section is operable, when a passenger makes a manual operation during cooling to change the air circulation mode from an inside air circulation mode to an outside air introduction mode, to change the deviation condition in a direction for allowing the engine to become more likely to be automatically stopped.

According to this feature, it becomes possible to increase a chance for the idle stop, based on a manual operation of changing the air circulation mode during cooling, from the inside air circulation mode to the outside air introduction mode, which is frequently performed by a passenger as a manual operation for easing the air-conditioning control. In addition, a chance for the idle stop is increased along with a change to the outside air introduction mode. This makes it possible to prevent or reduce an undesirable situation where exhaust gas emitted from the vehicle is introduced into the vehicle interior in connection with the outside air introduction.

### INDUSTRIAL APPLICABILITY

As described above, the present invention is suitably usable in a vehicle equipped with an air-conditioning system and having an idle stop function.

What is claimed is:

1. A vehicle air-conditioning control apparatus comprising:
an air-conditioning system which automatically controls a vehicle interior temperature to conform to a target vehicle interior temperature, in accordance with first parameters indicative of at least one of an environmental condition inside a vehicle interior and an environmental condition outside the vehicle interior, and a manual operation state set by a passenger;
an engine control section which automatically stops an engine of a vehicle, when a given automatic stop condition including a condition concerning a deviation between the target vehicle interior temperature and an actual vehicle interior temperature is satisfied during a stop of the vehicle; and
an automatic stop condition changing section which changes the deviation condition in a direction for allowing the engine to become more likely to be automatically stopped, when a passenger makes a manual operation during the automatic control of the air-conditioning system to change a second parameter other than the first parameters, in a direction for easing the air-conditioning control.

2. The vehicle air-conditioning control apparatus as defined in claim 1, wherein the second parameter is an airflow volume of conditioned air,
and wherein the automatic stop condition changing section is operable, when the passenger's manual operation is performed to reduce the airflow volume of conditioned air, to change the deviation condition in a direction for allowing the engine to become more likely to be automatically stopped.

3. The vehicle air-conditioning control apparatus as defined in claim 2, wherein, when the actual vehicle interior temperature during cooling becomes equal to or less than a threshold temperature set to a value higher than the target vehicle interior temperature, the deviation condition is determined to be fulfilled, and thereby the engine automatic stop is permitted,
and wherein the automatic stop condition changing section is operable, when the passenger's manual operation is performed to reduce the airflow volume of conditioned air, to increase the threshold temperature during the cooling from a first given temperature to a second given temperature higher than the first given temperature.

4. The vehicle air-conditioning control apparatus as defined in claim 2, wherein, when the actual vehicle interior temperature during heating becomes equal to or more than a threshold temperature set to a value lower than the target vehicle interior temperature, the deviation condition is determined to be fulfilled, and thereby the engine automatic stop is permitted,
and wherein the automatic stop condition changing section is operable, when the passenger's manual operation is performed to reduce the airflow volume of conditioned air, to reduce the threshold temperature during the heating from a third given temperature to a fourth given temperature lower than the third given temperature.

5. The vehicle air-conditioning control apparatus as defined in claim 3, wherein, when the actual vehicle interior temperature during heating becomes equal to or more than a threshold temperature set to a value lower than the target vehicle interior temperature, the deviation condition is determined to be fulfilled, and thereby the engine automatic stop is permitted,
and wherein the automatic stop condition changing section is operable, when the passenger's manual operation is performed to reduce the airflow volume of conditioned air, to reduce the threshold temperature during the heating from a third given temperature to a fourth given temperature lower than the third given temperature.

6. The vehicle air-conditioning control apparatus as defined in claim 3, wherein an amount of increase from the first given temperature to the second given temperature is set to a value which is unrelated to an amount of change in the airflow volume of conditioned air by a passenger.

7. The vehicle air-conditioning control apparatus as defined in claim 3, wherein an amount of increase from the first given temperature to the second given temperature is set to a value which is proportional to an amount of change in the airflow volume of conditioned air by a passenger.

8. The vehicle air-conditioning control apparatus as defined in claim 4, wherein an amount of decrease from the third given temperature to the fourth given temperature is set to a value which is unrelated to an amount of change in the airflow volume of conditioned air by a passenger.

9. The vehicle air-conditioning control apparatus as defined in claim 4, wherein an amount of decrease from the third given temperature to the fourth given temperature is set to a value which is proportional to an amount of change in the airflow volume of conditioned air by a passenger.

10. A vehicle air-conditioning control apparatus comprising:
an air-conditioning system which automatically controls a vehicle interior temperature to conform to a target vehicle interior temperature, in accordance with parameters indicative of at least one of an environmental condition inside a vehicle interior and an environmental condition outside the vehicle interior, and a manual operation state set by a passenger;
an engine control section which automatically stops an engine of a vehicle, when a given automatic stop condition including a condition concerning a deviation between the target vehicle interior temperature and an actual vehicle interior temperature is satisfied during a stop of the vehicle; and
an automatic stop condition changing section which changes the deviation condition in a direction for allowing the engine to become more likely to be automatically stopped, when a passenger makes a manual operation during the automatic control of the air-conditioning system to change an air circulation mode during cooling, from an inside air circulation mode to an outside air introduction mode.
